(19) United States
(12) Patent Application Publication
(10) Pub. No.: US 2007/0181007 A1
(43) Pub. Date: Aug. 9, 2007

(54) Basting device

(75) Inventor: David Chan, Scarborough (CA)

Correspondence Address: Gowling Lafleur Henderson LLP, 1 First Canadian Place, 100 King Street West, Suite 1600, Toronto, ON, M5X 1G5, US

(73) Assignee: Browne & Co., Markham (CA)

(21) Appl. No.: 11/607,904

(22) Filed: Dec. 4, 2006

Related U.S. Application Data
(60) Provisional application No. 60/771,487, filed on Feb. 9, 2006.

(51) Int. Cl. A47J 37/10

(52) U.S. Cl. 99/345

(57) ABSTRACT

The present invention provides a basting device comprising an elongate body portion defining a first passageway therethrough and having a distal and a proximal end and a resilient and flexible squeeze bulb having a collar portion located therein for removable attachment to the distal end of the body portion.

### FIELD OF THE INVENTION

The present invention relates to a basting device and in particular to a basting device having a removable bulb portion with a screw fit connection.

### BACKGROUND OF THE INVENTION

Basting devices are well known in the culinary field. Basting devices generally are used to extract and discharge liquids from and onto food items during cooking.

Traditional basters have a main body portion and a bulb at one end that includes a cavity within it. In order to extract liquid from a liquid reservoir, i.e. container or dish in which the food is cooking, the bulb is squeezed while the opposite end of the baster is out of the liquid. The tip of the baster is then placed in the liquid while the bulb is released and the liquid extracted is drawn into the body of the baster. In order to release the liquid the bulb is then squeezed and the liquid exits from the same aperture through which it was extracted.

In use such basters can leak, not only through the opening that the liquid enters and exits, but also between the connection of the baster body and the squeeze bulb. Any such leaking cannot only be frustrating due to the loss of liquid but can also harm a user if the liquid is warm or hot.

### SUMMARY OF THE INVENTION

The present invention provides a basting device comprising an elongate body portion having a passageway through it and having a resilient and flexible squeeze bulb with a collar portion located within it for removable attachment to one end of the body portion.

The present invention further provides a basting device having removable head portions including a showerhead type head portion and an injector.

In another aspect the present invention provides for the use of the basting device described herein.

### BRIEF DESCRIPTION OF THE DRAWINGS

The present invention will be discussed in further detail below with reference to the accompanying drawings in which:

FIG. 1 is a side isometric view of one embodiment of the basting device of the present invention;

FIG. 2 is an exploded view of the basting device of FIG. 1;

FIG. 3 is a side isometric view of a second embodiment of the basting device of the present invention;

FIG. 4 is an exploded view of the basting device of FIG. 3;

FIG. 5 is an embodiment of the collar portion of the basting device of the present invention;

FIG. 6 is a cross sectional view of the embodiment of FIG. 1; and

FIG. 7 is a cross sectional view of the embodiment of FIG. 3.

### DETAILED DESCRIPTION OF THE PREFERRED EMBODIMENTS

The present invention provides a basting device including a squeeze bulb that is removably connected to the body portion of the basting device using a screw fit.

The present invention will be described with reference to the Figures in which the basting device is indicated generally at numeral 10. The basting device 10 includes a body portion 12 with a removable head portion 14 and a squeeze bulb 16. The body portion 12 has a proximal end 18 and a distal end 20. Preferably the proximal end 18 is tapered for easier control of the flow and direction of fluid/liquid when the basting device is used without the head portion 14, as described below.

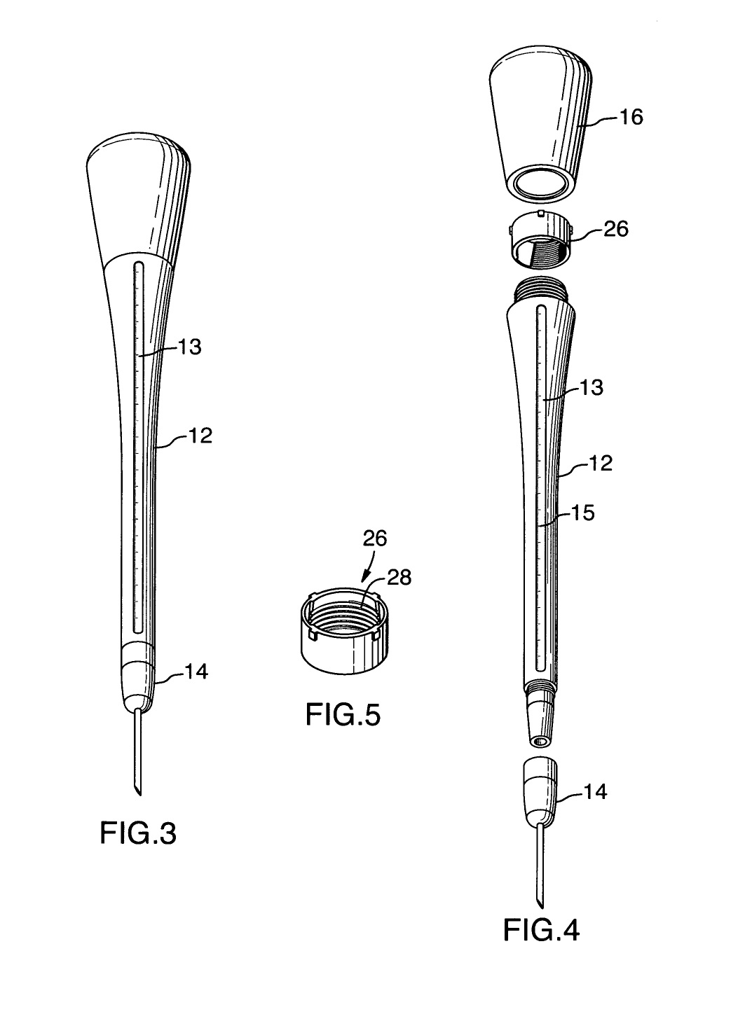

The body portion 12 of the basting device 10 may be made from any material that can be used to contain a liquid food product that is hot or cold. Preferably the body portion 12 is made from any material suitable for use in culinary applications, such as food grade plastics or metals such as stainless steel. Preferably the body portion 12 is made from polycarbonate. Preferably the body portion 12 includes at least one elongate portion that is clear or transparent to allow a user to identify the quantity of liquid contained within the body portion. To that end, and as can be seen more clearly in FIG. 3, the at least one elongate portion 13 preferably includes indicia 15 that represent volumetric measurements.

The squeeze bulb 16 of basting device 10 is flexible and resilient. It will be understood that a person skilled in the art will understand the types of material that may be used for the squeeze bulb, for example rubber or plastics. It will also be understood that the size of the squeeze bulb will be chosen in relation to the size of the basting device and in particular the size of the body portion and the passageway to be filled with liquid. It will be understood that larger body portions will be used in conjunction with larger squeeze bulbs.

The head portion 14 is attached to the body portion 12 at the proximal end 18 of the basting device 10. It will be understood by a person skilled in the art that any form of connection between the head portion 14 may be used to attach the head portion 14 securely to the body portion 12 to prevent the head portion 14 from separating from the body portion 12 during use. As will be seen more clearly in FIG. 2, the proximal end 18 of the body portion 12 of the illustrated embodiments includes a threaded portion 22. Likewise on an internal portion, not shown, of the head portion 14 there is a corresponding threaded portion that matingly engages with the threaded portion 22 of the proximal end 18 when the head portion 14 is connected to the body portion 12. In this embodiment, located between the head portion 14 and the body portion 12 is a gasket 23, shown in FIG. 2, also referred to as an o-ring. Gasket 23 provides a secure seal between the head portion 14 and body portion 12 that prevents leaks between these two parts.

As discussed above, the basting device 10 also includes a collar portion 26 that connects the squeeze bulb 16 to the body portion 12. The collar portion 26 is sized to releasably fit within the opening of the squeeze bulb 16. The fit of the collar portion 26 in the opening is preferably a friction fit. The collar portion 26 may include projections that assist in maintaining the frictional fit between the two parts.

The internal portion 28 of the collar portion 26, shown in FIG. 5, is threaded and is operable to connect with and thread onto a threaded portion 24 of the distal end 20 of the body portion 12. By threadingly engaging the collar portion, and attached to it the squeeze bulb 16, with the body portion 12 a seal between the passageway of the body portion 12 and the inner portion of the squeeze bulb is maintained to prevent liquid leaking onto a user at the point of connection of these parts. In addition the squeeze bulb 16 may be readily removed from the body portion 12 for cleaning. Further, the squeeze bulb 16 may be easily removed from the body portion 12 many times without cracking, which can occur in traditional basting devices and leads to a loss of vacuum in the basting device.

The collar portion 26 is preferably made from a material that is more rigid than the squeeze bulb 16 and assists in achieving a secure connection to the body portion 12. Preferably the collar portion 26 is made from polypropylene. However, it will be understood that the collar portion 26 may be made from any other material suitable for use in this application and operable to include a threaded portion to attach to the body portion 12 of the basting device 10 and to frictionally engage with the squeeze bulb.

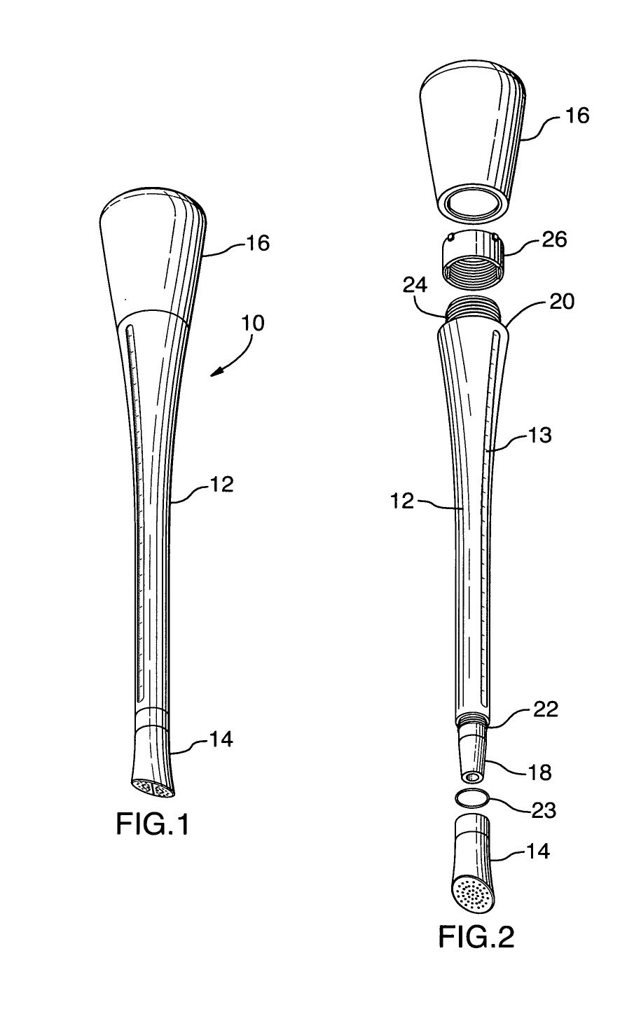

As can be seem in FIG. 1, the head portion 14 may be a shower type head portion. A shower type head portion allows a user to sprinkle liquid evenly across the surface to be covered. Alternatively, the head portion may include an injector, as indicated in FIGS. 3 and 4 that allows a user to inject liquid directly into a predetermined portion of a food product. The head portion 14 includes a passageway within that allows for liquid to pass through the head portion 14 and into the passageway of the body portion 12 when the head portion 12 is attached thereto. The basting device 10 of the present invention includes at least one removable head 14 that may include a shower type head, an injector or other head portions that will be known by a person skilled in the art. It will be understood that the basting device 10 of the present invention does not have to be used with the head portion 14.

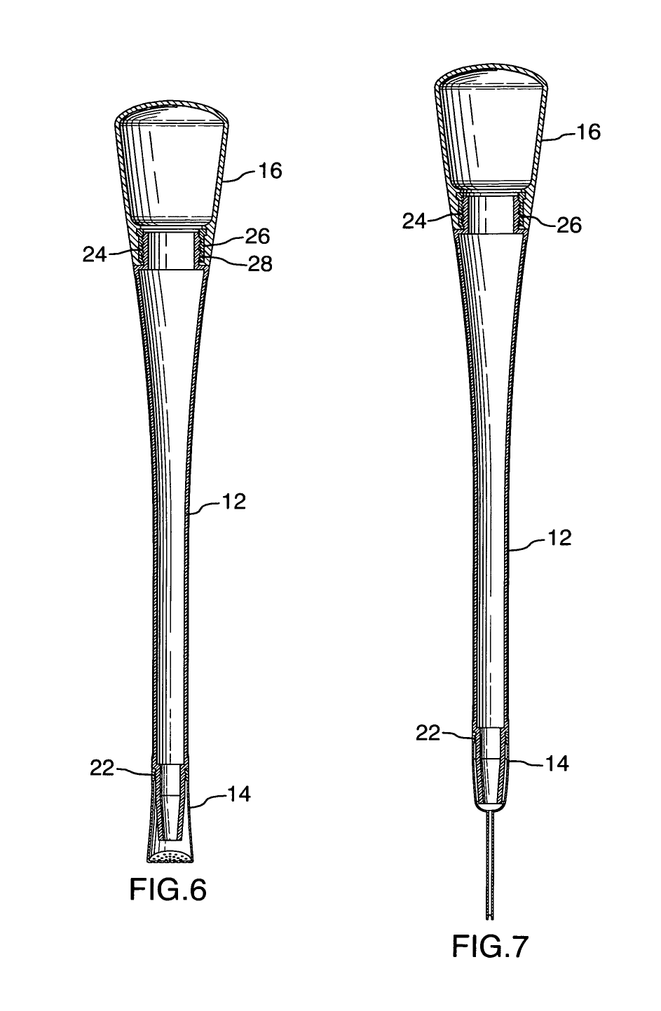

The cross sectional illustrations in FIGS. 6 and 7 show the fluid passageway located within the basting device 10 that allows liquid to be drawn into the basting device 10 through the head portion 14 and up into the body portion 12. These figures also illustrate the threaded connection of the squeeze bulb 16 to the body portion 12 by way of the collar portion 26.

The use of the basting device 10 of the present invention is as per any basting device. Liquid may be drawn into the basting device 10 by first squeezing the bulb portion and then placing at least a portion of the proximal end 18, including the head portion 14 if used, within the liquid to be extracted. The squeeze bulb 16 may then be released and the liquid will be extracted up into the passageway of the body portion 12. When the user wishes to discharge the liquid the squeeze bulb 16 is squeezed and liquid forced from the body portion 12. If a particular amount of liquid is used the indicia located on at least a portion of the body portion may be used to accurately measure the amount of liquid being extracted and/or discharged. When a user wishes to clean the basting device 10 or store the device, the squeeze bulb 16 can easily be unscrewed from the body portion 12.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

What is claimed is:

1. A basting device comprising:
an elongate body portion defining a first passageway therethrough and having a distal and a proximal end; and
a resilient and flexible squeeze bulb having a collar portion for releasable attachment to the distal end of the body portion, the collar portion having greater rigidity than the squeeze bulb.

2. The basting device according to claim 1, further comprising at least one removable head portion releasably attached to the proximal end of the body portion having a passageway therein for alignment with the first passageway of the tube when attached thereon.

3. The basting device according to claim 1, wherein the collar portion is connected to the distal end of the body portion by a screw fit.

4. The basting device according to claim 1, wherein the collar portion is frictionally held within the squeeze bulb.

5. The basting device according to claim 2, wherein the at least one removable head portion comprises a plurality of spaced apertures for showering a basting liquid.

6. The basting device according to claim 2, wherein the at least one removable head portion includes an injector portion.

7. The basting device according to claim 1, wherein at least a portion of the body portion, extending substantially along the length of the body portion, includes a clear window for viewing liquid contained therein and having volume indicia thereon.

8. The basting device according to claim 1, wherein the body portion is transparent.

9. The basting device according to claim 2, further comprising a gasket located between the head portion and the body portion.

10. A basting device comprising:
an elongate body portion defining a first passageway therethrough and having a distal and a proximal end;
a collar portion releasably attached to the distal end of the body portion; and
a resilient and flexible squeeze bulb releasably connected to the collar portion.

11. The basting device according to claim 10, wherein the collar portion and distal end are operable to threadingly engage.

12. The basting device according to claim 10, wherein the collar portion and the squeeze bulb are operable to frictionally engage and the collar portion having greater rigidity than the squeeze bulb.

13. The basting device according to claim 10, further comprising at least one removable head portion releasably attached to the proximal end of the body portion having a passageway therein for alignment with the first passageway of the tube when attached thereon.

14. The basting device according to claim 13, wherein the at least one removable head portion is shower head like.

15. The basting device according to claim 13, wherein the at least one removable head portion includes an injector portion.

16. The basting device according to claim 10, wherein at least a portion of the body portion, extending substantially along the length of the body portion, includes a clear window for viewing liquid contained therein and having volume indicia thereon.

17. The basting device according to claim 10, wherein the body portion is transparent.

18. The basting device according to claim 13, further comprising a gasket located between the head portion and the body portion.
